(19) United States
(12) Patent Application Publication
(10) Pub. No.: US 2015/0199011 A1
(43) Pub. Date: Jul. 16, 2015

(54) ATTRACTIVE AND REPULSIVE FORCE FEEDBACK

(71) Applicant: Microsoft Corporation, Redmond, WA (US)

(72) Inventors: Masaaki Fukumoto, Beijing (CN); Taku Hachisu, Beijing (CN)

(73) Assignee: Microsoft Corporation, Redmond, WA (US)

(21) Appl. No.: 14/154,801

(22) Filed: Jan. 14, 2014

(51) Int. Cl. G06F 3/01

(52) U.S. Cl. CPC G06F 3/016

(57) ABSTRACT

In some examples, a touch surface includes at least one hole formed in the touch surface. In some instances, a touch sensor is associated with the touch surface for detecting the position of an input object relative to the touch surface. Additionally, in some cases, the touch surface may be associated with a display. Suction may be applied to the at least one hole based on at least one of an image presented on the display, or a position of the input object in relation to the touch surface. As one example, there may be a plurality of holes formed in the touch surface. Suction may be applied to a first hole of the plurality of holes and pressurized air may be emitted from a second hole of the plurality of holes.

### BACKGROUND

Computers and other types of electronic devices typically present information to a user in the form of a graphical output or other type of image presented on a display. Furthermore, some electronic devices receive input from users through contact with the display, such as via a fingertip or stylus. For example, a user may perform certain gestures using a fingertip, such as for interacting with a user interface, interacting with digital content, or performing other types of interactions. In some cases, when interacting with a user interface, the user may receive visual feedback and/or auditory feedback. Additionally, some types of electronic devices may provide haptic or other tactile feedback, which may include applying forces, vibrations, or motions to the user. As electronic devices that include touch input capability become more ubiquitous, enhancing feedback to users of these electronic devices continues to be a priority.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

In some examples, attractive and/or repulsive forces may provide feedback to a user during interaction with touch surface. For instance, the touch surface may include one or more holes for providing fluid-based repulsive or attractive forces to an input object proximate to the touch surface. As one example, the touch surface may include a plurality of holes, each able to exert a suction force and/or a pressurized air force on the touch object when the touch object is sufficiently proximate to the hole. In some cases, the touch surface may be associated with a display, such as by being included on a surface of the display, or by being otherwise connected for enabling user interaction with an image presented on the display via the touch surface.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example apparatus configured to provide attractive and repulsive force feedback according to some implementations.

FIGS. 2A-2F illustrate example interactions with an attractive force according to some implementations.

FIGS. 3A-3F illustrate example interactions with a repulsive force according to some implementations.

FIGS. 4A-4D illustrate example interactions with a user interface graphic element according to some implementations.

FIGS. 5A-5D illustrate example interactions with a user interface graphic element according to some implementations.

FIG. 6 illustrates an example apparatus configured to provide attractive and repulsive force feedback according to some implementations.

FIG. 7 illustrates an example of using attractive and repulsive force feedback during presentation of an image according to some implementations.

FIG. 8 illustrates an example of using attractive and repulsive force feedback during presentation of an image according to some implementations.

FIG. 9 illustrates an example apparatus to provide attractive and repulsive force feedback with a projection display according to some implementations.

FIG. 10 illustrates an example apparatus to provide attractive and repulsive force feedback with a microelectromechanical system (MEMS) display according to some implementations.

FIG. 11 illustrates select components of an example electronic device according to some implementations.

FIG. 12 is a flow diagram of an example process for providing tactile feedback according to some implementations.

FIG. 13 is a flow diagram of an example process for providing tactile feedback according to some implementations.

FIG. 14 is a flow diagram of an example process for providing tactile feedback according to some implementations.

### DETAILED DESCRIPTION

This disclosure describes techniques and arrangements for providing attractive and/or repulsive forces that are detectable by a user during interaction with an apparatus including a touch surface. For instance, the apparatus may provide at least one of an attractive force or a repulsive force to an input object, such as a finger, stylus, or the like, that is on or proximate to the touch surface. In some cases, the apparatus may enable more effective user interaction than conventional touch surfaces by providing both attractive and repulsive tactile feedback. In some examples, the apparatus may provide the tactile feedback in combination with a touch screen display that may present a graphic user interface (GUI) including features such as buttons, sliders, dials, and the like, or various other images. For example, the tactile feedback techniques herein may be used to attract the input object to certain areas of a displayed image and repel the input object from other areas of the displayed image.

The apparatus may include a touch surface having at least one hole, a suction source, such as a vacuum tank, a valve between the suction source and the hole for controlling an amount of suction at the hole. The apparatus may further include an input-object-position detector, such as a touch sensor, to determine when to activate the suction at the hole, such as to attract the input object to the hole, when the input object is placed on or sufficiently close to the hole to feel or to be affected by the suction force. In some examples, the apparatus may include a touch surface having a plurality of holes that may be selectively connected to at least one of a suction source and a source of pressurized air, with valves for controlling airflow to the suction source and airflow from the pressurized air source. As one example, the valves may be controlled so that some of the holes emit pressurized air, while others of the holes may draw in air to the suction source. The emission or intake of air at the various holes may be coordinated based on a detected location of the input object and/or may be coordinated based on the presentation of one or more images presented on a display associated with the touch surface.

For discussion purposes, some example implementations are described in the context of providing attractive and/or repulsive force feedback for a touch surface associated with a display of an electronic device. However, the implementations herein are not limited to the particular examples provided, and may be extended to other types of touch surfaces, other types of displays, other types of electronic devices, other modes of operation, and other uses, as will be apparent to those of skill in the art in light of the disclosure herein.

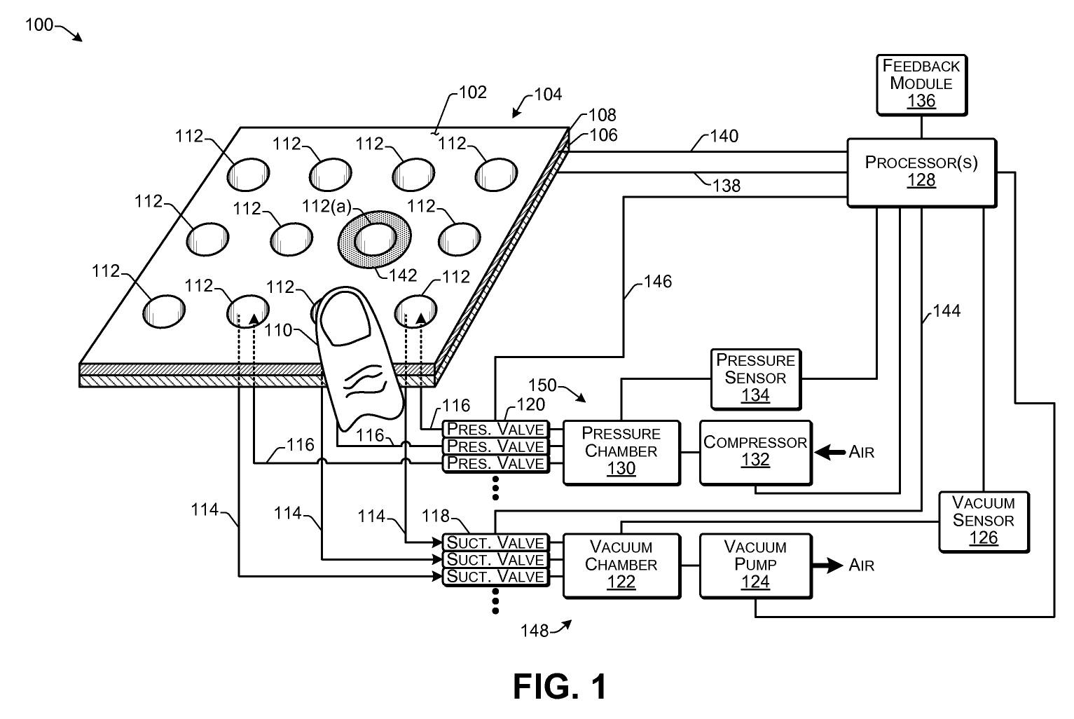

FIG. 1 illustrates an example apparatus 100 that may include a touch surface 102 according to some implementations. In some examples, the touch surface 102 may be integral with a display 104, such as a liquid crystal display (LCD) panel 106 in this example, or any other suitable type of active or passive display, examples of which are enumerated in further detail below. Further, in other examples, the touch surface 102 may not be integral with the display, such as in the case that the touch surface 102 is included in a touch pad or other type of touch input device. For instance, a touch pad may be associated with a display that is separate from the touch pad, and the touch pad may receive input gestures, such as for interacting with an image presented on the display or for performing other functions. Alternatively, in other examples, the touch surface 102 may also serve as the display 104, such as in the case of a projected image being projected onto the touch surface 102.

The touch surface 102 may further include a touch sensor 108 that can detect a location of an input object 110 relative to the touch surface 102. The touch sensor 108 may be integral with the touch surface 102 in some examples, or separate from the touch surface 102 in other examples. For instance, the touch sensor 108 may be a capacitive or resistive touch sensor located on or below the touch surface 102. As one example, the touch sensor 108 may include a grid of crossed electrode elements (not shown for clarity of illustration), including a first set of parallel conductor lines that extend across the touch surface in a first direction, and a second set of parallel conductor lines that extend across the first set of conductor lines, either perpendicularly, or at an oblique angle. In some cases, the conductor lines may be constructed of a transparent conductive material, such as indium tin oxide, so that the touch sensor 108 may be positioned over the display 104 without degrading the quality of the image presented on the display. In other examples, the touch sensor 108 may be positioned under the display 104. In some cases, the touch sensor 108 may be tuned to detect inputs from the input object 110 hovering over the touch surface 102 in addition to, or as an alternative to, touching the touch surface 102.

Further, as an alternative example (not shown in FIG. 1), the touch sensor 108 may include a plurality of light ray emitters and a plurality of light sensors, such as a plurality of light emitting diodes (LEDs) for emitting infrared (IR) light rays and a plurality of IR light sensors. For example, the IR light rays may be projected over and across the touch surface 102 and detected by the IR light sensors. When one or more of the light rays are interrupted by an input object 110, the position of the input object 110 may be determined relative to the touch surface 102 based on which light rays are interrupted. As still another example, a camera (e.g., IR, visible light, etc.), a laser range finder, or other sensor may be used to detect the position of the input object 110 relative to the touch surface.

The input object 110 may be a finger or any other appendage or body part of a user. Alternatively, as another example, the input object 110 may be a stylus, such as an active or passive stylus useable with the touch sensor 108, or any other suitable type of input object.

The touch surface 102 may include one or more holes 112, which may have a diameter smaller than that of the input object 110 in some examples. The holes 112 may each be connected to at least one of a suction line 114 or a pressure line 116. In the illustrated example, each hole 112 is connected to both a suction line 114 and a pressure line 116 (not all suction lines 114 and pressure lines 116 are shown in the example of FIG. 1 for clarity of illustration). Further, each suction line 114 may be connected to a controllable suction valve 118, and each pressure line 116 may be connected to a controllable pressure valve 120. Accordingly, the valves 118 and 120 may be controlled to determine whether the corresponding hole 112 draws air inward or emits air outward.

The suction lines 114 may be connected, via the respective suction valves 118, to a vacuum chamber 122, which maintains a vacuum through operation of a vacuum pump 124. For example, a vacuum sensor 126 may detect the level of the vacuum in the vacuum chamber 122 and provide vacuum sensor information to one or more processors 128. If the pressure in the vacuum chamber 122 rises above a predetermined threshold pressure, the one or more processors 128 may activate the vacuum pump 124 to cause air to be expelled from the vacuum chamber 122, thereby lowering the vacuum pressure to a desired threshold level. As one example, the vacuum level in the vacuum chamber may be maintained at a pressure between approximately 1×10⁺⁴ to 1×10⁻¹ Pa, although other suitable vacuum levels may be used, depending on the system configuration and the intended use of the apparatus 100.

Similarly, the pressure lines 116 may be connected via the respective pressure valves 120 to a pressure chamber 130 that receives pressurized air from a compressor 132. For example, a pressure sensor 134 may detect the air pressure level in the pressure chamber 130 and may provide pressure sensor information to the one or more processors 128. When the air pressure in the pressure chamber 130 falls below a threshold level, the one or more processors 128 may activate the compressor 132 to increase the air pressure in the pressure chamber 130. As one example, the pressure level in the pressure chamber 130 may be maintained at a pressure between approximately 1.2×10⁺⁵ to 2×10⁺⁶ Pa, although other suitable pressure levels may be used depending on the system configuration and the intended use of the apparatus 100. Furthermore, in some examples, the vacuum pump 124 and the compressor 132 may be combined as a single air pump able to both draw a vacuum on the vacuum chamber 122 and compress air in the pressure chamber 130.

A feedback module 136 may be executed by the one or more processors 128 to control the airflow to and from the holes 112 and the touch surface 102. For example, the one or more processors 128 may be electrically connected to the display 104 and the touch sensor 108 via respective electrical connections 138 and 140. The one or more processors 128 may cause an image to be displayed on the display 104 through the electrical connection 138. In addition, the one or more processors 128 may receive touch sensor input through the electrical connection 140 determine the position of the input object 110 with respect to the touch surface 102. The feedback module may determine which holes 112 to which to apply suction or pressurized air based on information from the touch sensor regarding the position of the input object and/or based on the image presented on the display. In some examples, the image presented on the display may have associated instructions for controlling airflow at the holes 112. For example, a map, book, application or operating system may include instructions for controlling airflow in relation to various images. In other examples, the feedback module 136 may analyze the presented image for determining how to apply airflow at the holes 112, some examples of which are discussed further below.

As one example, suppose that an icon, button, or other graphic element image 142 is presented on the display 104 in a location corresponding to a particular hole 112(a). Based at least in part on at least one of the image presented on the display 104 and/or a detected position of the input object 110, the feedback module 136 may determine which suction valves 118 and/or pressure valves 120 to open. For instance, each of the valves 118 and 120 for each hole 112 may be independently operated and selectively controlled by the feedback module 136 such as through one or more suction valve control connections 144 and one or more pressure valve control connections 146. As one example, when the input object 110 is detected near a position on the touch surface 102 where the user is expected to make a touch input, such as the graphic element image 142, a suction force may be applied to the particular hole 112(a) closest to the location on the touch surface 102 where the touch input is expected. Further, repulsive forces may be emitted from other ones of the holes 112 where the touch input is not expected, such as for guiding the input object 110 to make the touch input at the expected location. Of course, in other examples, each hole 112 of a plurality of the holes 112 may have its own associated graphic element 142 and, thus, the respective suction valves may be opened for each particular hole 112 when the input object 110 is detected at a location that is proximate to the particular hole 112, such as when the input object 110 is closer to the particular hole 112 than to other ones of the holes 112.

Together, the vacuum chamber 122 and the vacuum pump 124 provide a suction source 148 that is selectively connectable to individual ones of the holes 112 by operation of the respective suction valves 118. Similarly, together, the pressure chamber 130 and the compressor 132 provide a pressurized air source 150 that is selectively connectable to individual ones of the holes 112 by operation of respective pressure valves 120. Further, while the vacuum chamber 122 and vacuum pump 124 are illustrated as one example of the suction source 148, numerous alternative devices and configurations will be apparent to those of skill in the art having the benefit of the disclosure herein. As one alternative, a vacuum plenum may be located under the touch surface 102, the suction valves 118 may be located at or near the touch surface 102, and the suction lines 114 may be eliminated. Similarly, while the pressure chamber 130 and compressor 132 are illustrated as one example of the pressurized air source 150, numerous alternative devices and configurations will be apparent to those of skill in the art having the benefit of the disclosure herein. As one alternative, a pressurized air plenum may be located under the touch surface 102, the pressure valves 120 may be located at or near the touch surface 102, and the pressure lines 116 may be eliminated.

Furthermore, in some cases, the valves 118 and 120 may be controlled in a manner that is variable between an opened position and a closed position, such as for controlling the amount of air expelled or an amount of suction exerted at each hole 112. For instance, an operation voltage applied to each valve 118 and 120 may control the amount that the respective valve is opened. As one example, each valve 118 and 120 may operated with five different settings, referred to as 0, 1, 2, 3 and 4 for the pressure valves 120 and 0, −1, −2, −3 and −4 for the suction valves 118, and which may correspond respectively to closed, 25% open, 50% open, 75% open, and 100% open. Furthermore, in other examples, the valves 118 and 120 may merely have an opened or closed position, while is still other examples, the valves may be infinitely variable based on the variability of the applied voltage, or may have other variable granular degrees of being opened. Consequently, the amount of attractive suction force experienced by an input object 110 at each hole 112 may be a function of hole diameter, level of suction pressure in the vacuum chamber 122, and the amount that the respective suction valve 118 is opened. Similarly, the amount of repulsive air pressure force experienced by an input object at each hole 112 may be a function of hole diameter, level of air pressure in the pressure chamber 130, and the amount that the respective pressure valve 120 is opened.

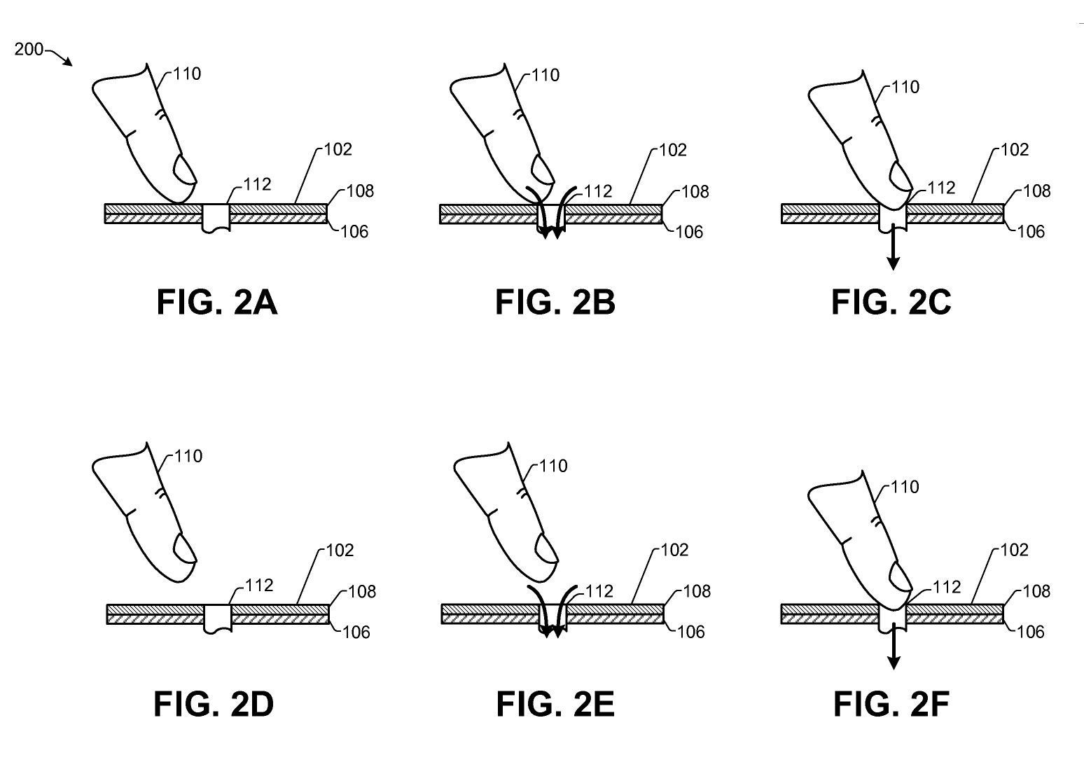

FIGS. 2A-2F illustrate example user interactions 200 with respect to the touch surface 102 when suction is applied to a hole according to some implementations. FIGS. 2A-2C illustrate a first example interaction in which the input object 110 e.g., a finger of a user, is in contact with the touch surface 102 such as during a drag or swipe operation. For instance, as illustrated in FIG. 2A, suppose that the user is moving the input object 110 across the touch surface 102 toward the hole 112. The feedback module 136 discussed above with respect to FIG. 1 may determine the location of the input object 110 and may open the respective suction valve corresponding to the hole 112, as illustrated in FIG. 2B. The suction may cause the input object 110 to be drawn toward and stick at the hole 112, as illustrated in FIG. 2C. Accordingly, the attractive force caused by the suction at each hole 112 may result in the ability to attract the input object 110 to particular discrete locations on the touch surface 102.

As one example, the image presented by the display may be configured to correspond to the positions of the one or more holes 112. For instance, a GUI may be designed or configured to position particular controls or other interface features at the particular locations on the display corresponding to the locations of the holes 112 on the touch surface 102. Further, the suction force may remain applied to provide a sticking effect such that the user receives positive feedback indicating that the user has touched a known position. When the user removes the input object, the suction valve for that hole may remain open, or may be fully or partially closed.

FIGS. 2D-2F illustrate a second example interaction in which the input object is hovering over the touch surface 102. For example, as mentioned above, certain types of touch sensors, such as capacitive touch sensors and light-based touch sensors are able to detect the position of an input object even when the input object is not in contact with the touch surface 102. Accordingly, in this example as the input object 110 is detected approaching the hole 112, the feedback module may open the suction valve corresponding to the hole 112, as illustrated in FIG. 2E. As one example, the proximate distance for opening the suction valve may be 0.5-2 cm, depending on the responsiveness of the valve, the level of suction applied, and so forth. The resulting suction force may help guide the input object 110 toward a desired location on the touch surface 102, as illustrated in FIG. 2F. Further, the suction force may remain applied to provide a sticking effect such that the user receives positive feedback indicating that the user has touched a known position. When the user removes the input object, the suction valve for that hole may remain open, or may be fully or partially closed.

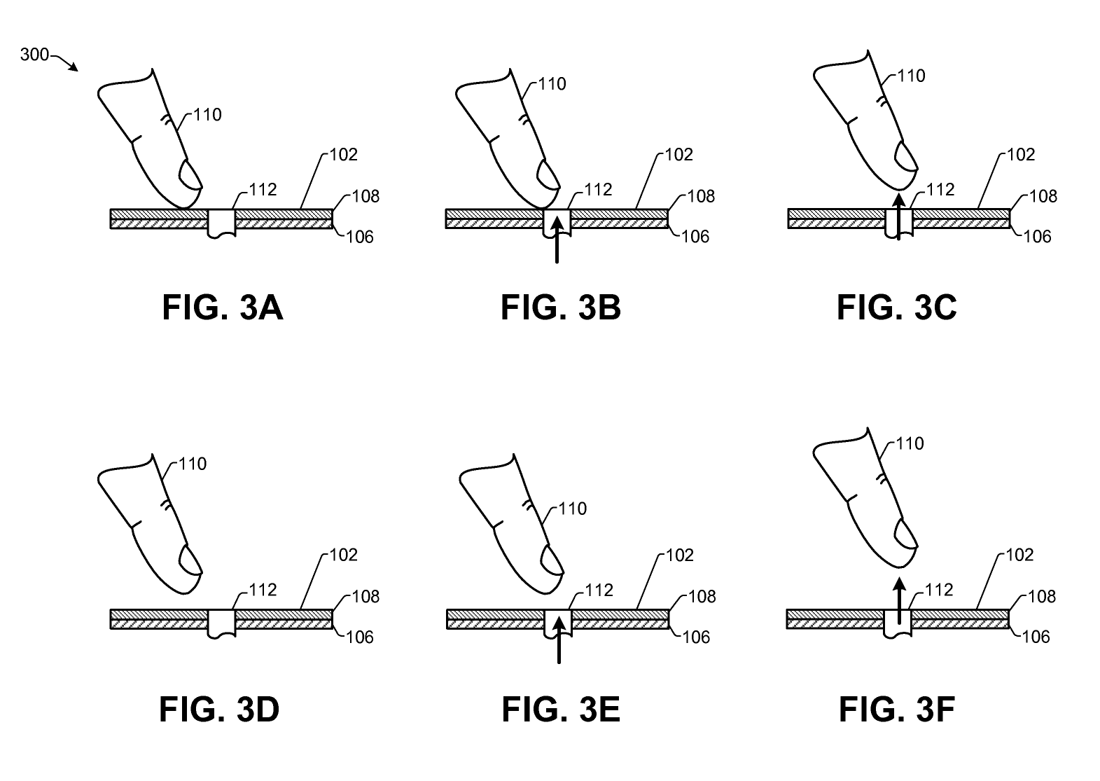

FIGS. 3A-3F illustrate example user interactions 300 with the touch surface 102 when pressurized air is applied to a hole according to some implementations. FIGS. 3A-3C illustrate a first example interaction in which the input object 110 e.g., a finger of a user, is in contact with the touch surface 102 such as during a drag or swipe operation. For instance, as illustrated in FIG. 3A, suppose that the user is moving the input object 110 across the touch surface 102 toward the hole 112. The feedback module may determine the location of the input object 110 and may open the respective pressure valve corresponding to the hole 112, as illustrated in FIG. 3B. The pressurized air emitted from the hole 112 may cause the input object 110 to be pushed away from the hole 112, as illustrated in FIG. 3C. Accordingly, the repulsive force caused by the pressurized air emitted from the hole 112 may result in the ability to repel the input object away from particular discrete locations on the touch surface 102. When the input object 110 is removed a threshold distance from the hole 112, the pressure valve for that hole may remain open, or may be fully or partially closed.

As one example, the image presented on the display 104 may be configured to correspond to the positions of some of the holes 112, and not others. As one example, a GUI may be designed or configured to position particular controls or other interface features at particular locations on the display corresponding to the locations of some of the holes 112, as discussed above with respect to FIG. 2. Others of the holes 112, such as the hole 112 illustrated in FIGS. 3A-3F, may not have a GUI feature associated therewith, and thus, may provide a repulsive force to help guide the touch object 110 toward another location on the touch surface 102. As another example, as discussed below, repulsive effects and or suction effects may be applied to provide various types of tactile feedback such as for simulating elevations on a map, wind currents, ocean currents, barriers, and various other features.

FIGS. 3D-3F illustrate a second example interaction in which the input object 110 is hovering over the touch surface 102. In this example, as the input object 110 is detected approaching the hole 112, the feedback module may open the pressure valve corresponding to the hole 112, as illustrated in FIG. 3E. The resulting repulsive force may help guide the input object 110 away from the hole 112 and toward another desired location on the touch surface 102, as illustrated in FIG. 3F. When the user removes the input object 110 a sufficient distance from the hole 112, the suction valve for that hole 112 may remain open, or may be fully or partially closed.

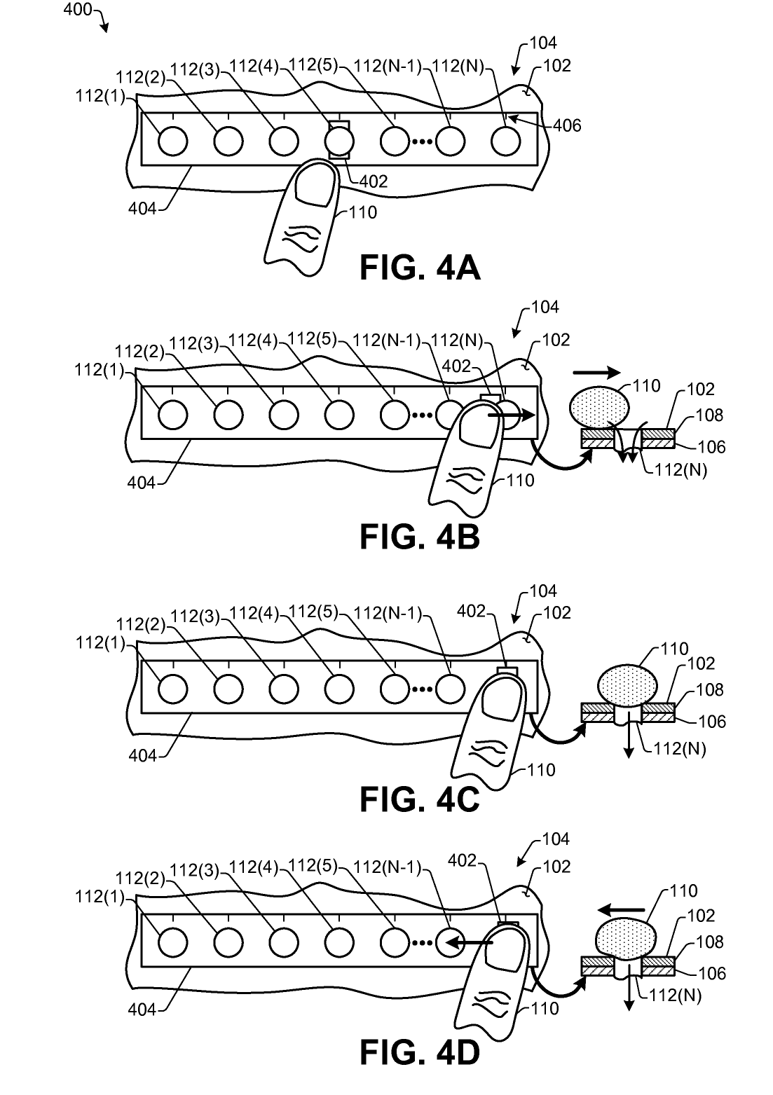

FIGS. 4A-4D illustrate an example graphical element 400 of a user interface presented on a display associated with the touch surface 102 according to some implementations. In this example, the graphical element 400 includes a slider element 402 within a graphical slider boundary 404. For example, the slider element 402 and boundary 404 provide a virtual control to a user via an image presented on the display 104. The user may use the input object 110 for moving the slider element 402 left or right within the slider boundary 404, such as for performing one or more functions. Examples of such functions may include functions performed using audio setting controls, video or audio scrubbing controls, color controls, brightness controls, contrast controls, and numerous other types of controls. In some instances, the slider boundary 404 may include numeric values, gradations, graduations, or other types of markings 406 that may coincide with the locations of the holes 112, such as to indicate sequential changes in a value represented by the slider. Additionally, in other examples, the slider may be vertically configured for up/down motion, or may be configured for sliding motion in any other desired direction.

As one example, suppose that the user touches the slider element 402 with a finger (i.e., touches the location on the display 104 where the image of the slider element 402 is represented), and slides the slider element 402 to the right, as illustrated in FIG. 4B. In some cases, the suction valves corresponding to all the holes 112(1), 112(2), . . . , 112(N) within the slider boundary may be opened when the input object 110 is detected on or near the touch surface 102. Thus, as the user employs the input object 110 to move the slider element 402 from a current positioned to a next position, the input object 110 may encounter a sticking point at each of the holes 112 corresponding to each of the markings 406, which may provide a clicking-like experience as the user slides the slider element over the areas corresponding to where the holes 112 are located.

As another example, the valves corresponding to the holes 112(1)-112(N) may be controlled based on the location of the input object 110, the position of the slider element 402, and the direction of movement or anticipated direction of movement. For example, the user may touch the slider element 402 at the current location illustrated in FIG. 4A, and there may be no suction or a lower level of suction currently applied to the hole 112(4). The user may begin to slide the slider element 402 to the right, as illustrated in FIG. 4B, and suction may be successively applied to each hole 112(5)-112(N), such as by opening the suction valve for hole 112(5) as the slider element 402 moves towards the hole 112(5), opening the suction valve for the hole 112(N−1) as the slider element 402 is moved past the hole 112(5), and opening the suction valve for the hole 112(N) as the slider element 402 is moved past the hole 112(N−1). Additionally, in some cases, as the slider element 402 is moved past a particular hole 112, that hole may be transitioned from a suction mode to a positive pressure mode, such as by opening the pressure valve corresponding to the particular hole and closing the suction valve corresponding to the particular hole.

In addition, as illustrated in FIG. 4C, as the input object 110 reaches the end-position hole 112(N) within the graphic boundary 404 of the slider graphical element 400, a larger amount suction may be applied to the end-position hole 112(N) (or the end position hole 112(1) on the left side), than was applied to the intermediate holes 112(2)-112(N−1) during traversal of the intermediate holes 112(2)-112(N−b). Accordingly, the end-position holes 112(N) and 112(1) may create a larger sticking point as illustrated in FIG. 4D, which may provide a tactile feedback to indicate to the user that the user has reached an end position of the slider graphical element 400.

As one example, the vacuum applied to the intermediate holes 112(2)-112(N−b) may include the corresponding suction valves being opened only 25 to 50%, while the suction valves for the end-position holes may be opened 75 to 100%. Accordingly, the user may experience a click-like tactile feedback when moving the slider element 402 across the intermediate holes 112(2)-112(N−b). Further, there will be a different tactile feedback to the user when encountering the end-position holes 112(N) and 112(1), such as greater deformation of the input object 110 and a larger sticking or suction force, which will be detectable by the user, such as when the user tries to move the slider element 402 past the end-position hole or back in the other direction, as illustrated in FIG. 4D. Further, since the human finger has some deformability, when the input object 110 has been detected to have moved partially away from the end-position hole in the reverse direction, indicating movement back toward the center of the slider, the suction at the end-position hole may be decreased or turned off altogether, such as when the displacement of the input object from the end-position hole 112(N) is larger than a threshold amount.

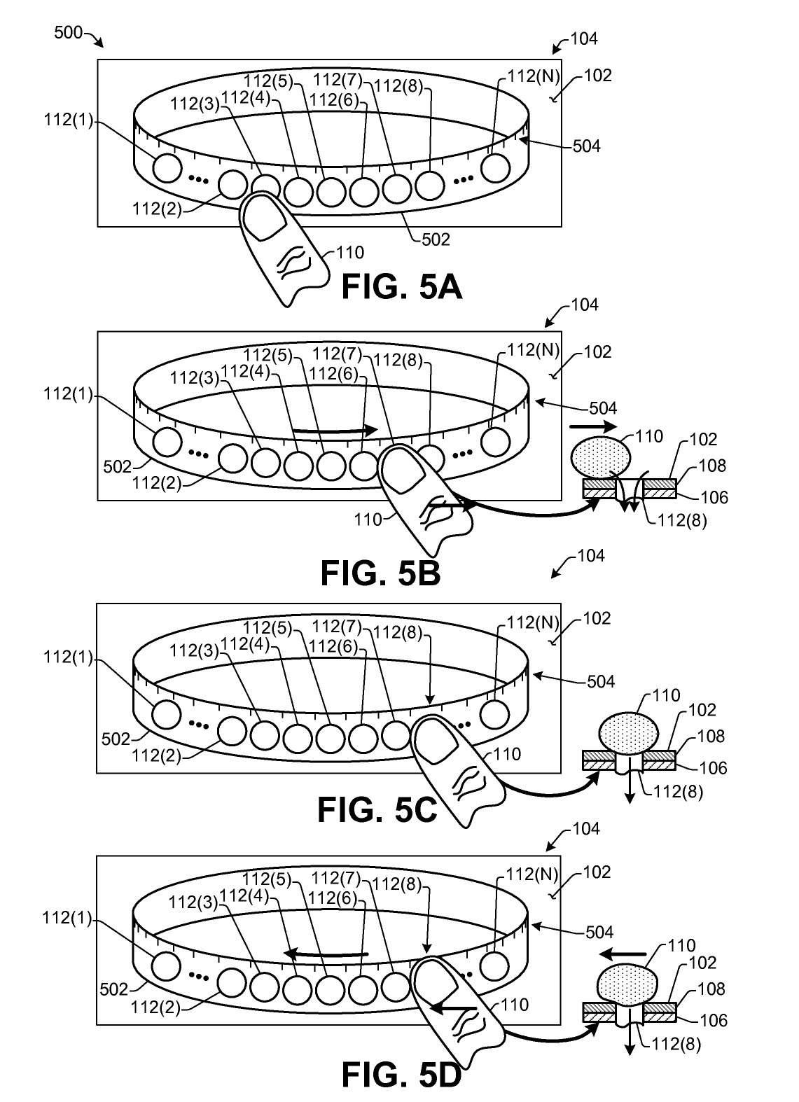

FIGS. 5A-5D illustrate an example graphical element 500 of a UI presented on a display associated with the touch surface 102 according to some implementations. In this example, the UI 500 includes a graphical carousel or dial element 502 that is left/right rotatable by user input. For example, the dial 502 provides a virtual control to the user as an image presented on the display 104. Further, in the illustrated example, the holes 112(1)-112(N) are arranged in an arc-shaped pattern, rather than in a straight line, and the dial 502 may be presented in a perspective view having an arc shape that matches that of the hole pattern. In other examples, however, the holes 112(1)-112(N) may be arranged in a straight line, and the dial may be graphically presented as a side view, rather than as a perspective view. Additionally, in other examples, the dial may be vertically configured for up/down rotation, or may be configured for rotation in any other desired direction.

As one example, the user may operate the dial 502 in a manner similar to the slider element discussed above with respect to FIG. 4. For instance, the user may use the input object 110 for rotating the image of the dial 502 left or right, such as for performing one or more functions. Examples of such functions may include functions for audio setting controls, video or audio scrubbing controls, color controls, brightness controls, contrast controls, and numerous other types of control functions. In some instances, the dial 502 may include numeric values, gradations, graduations or other types of markings 504 that may rotate with the dial. When the dial 502 is configured to operate in a manner similar to the slider element of FIG. 4, the user may rotate the dial 502, and suction may be sequentially applied to the holes 112 as the position of the input object 110 is detected to be approaching each hole 112.

As one example, suppose that the user touches the dial 502 with a finger (i.e., touches the location on the touch surface 102 corresponding to where the image of the dial 502 is represented), and moves the input object 110 to the right, as illustrated in FIG. 5B. In some cases, the suction valves corresponding to all the holes 112(1)-112(N) may be opened when an input object 110 is detected on or near the touch surface 102. Thus, as the user employs the input object 110 to move the dial 502 from a current position to a new position, the input object 110 may encounter a sticking point at each of the holes 112, thus providing a clicking type of feedback to the user when rotating the dial.

As another example, the valves corresponding to the holes 112(1)-112(N) may be controlled based on the detected position of the input object 110 and the direction of movement or anticipated direction of movement. For instance, as the input object 110 is moved from hole 112(6) to 112(7), suction may be applied to hole 112(7) and disconnected from hole 112(6). Thus, suction may be successively applied to each hole 112(6)-112(8), etc., as the input object 110 is moved toward each successive hole. Additionally, in some cases, as the input object 110 is moved past a particular hole, that hole 112 may be transitioned from a suction mode to a positive pressure mode, such as by opening the pressure valve corresponding to the particular hole and closing the suction valve corresponding to the particular hole.

In addition, some types of dials may have minimum and maximum limit values, and are not permitted to rotate over these limits. As illustrated in FIG. 5C, suppose that the maximum value for the dial 502 corresponds to the location of hole 112(8) and that the minimum value for the dial 502 corresponds to the location of hole 112(2). Thus, these holes 112(2) and 112(8) may correspond to limit positions for the particular dial 502. Consequently, as the input object 110 reaches the rightmost (e.g., maximum) limit of the current dial condition (in this example: limit-position hole 112(8)), a larger amount suction may be applied to the limit-position hole 112(8) (or, similarly, at the leftmost limit of current dial condition (in this example: limit-position hole 112(2)), than was applied during traversal of the intermediate holes 112(3)-112(7). Accordingly, the limit-position holes 112(8) and 112(2) may create a larger sticking point as illustrated in FIG. 5D, which may provide a tactile feedback to indicate to the user that the user has reached a limit position of the dial 502.

As one example, the vacuum applied to the intermediate holes 112(3)-112(7) may include the corresponding suction valves being opened only 25 to 50%, while the suction valves for the limit-position holes may be opened 75 to 100%. Accordingly, the user may experience a click-like tactile feedback when moving the input object 110 across a plurality of the intermediate holes 112(3)-112(7). Further, there will be a different tactile feedback to the user when encountering the limit-position holes 112(8) and 112(2), such as greater deformation of the input object 110 and a larger sticking or suction force, which will be detectable by the user, such as when the user tries to rotate the dial 502 past the limit-position hole 112(8) or back in the other direction, as illustrated in FIG. 5D. Further, since the human finger has some deformability, when the input object 110 has been detected to have moved in the reverse direction, partially away from the limit-position hole 112(8), indicating movement back toward the center of the dial 502, the suction at the limit-position hole 112(8) may be decreased or turned off altogether, such as when the displacement of the input object 110 from the limit-position hole 112(8) is larger than a threshold amount.

As an alternative example, a larger amount of suction may be applied to a centrally located hole, such as hole 112(5), than to the other holes 112(1)-112(4) and 112(6)-112(N). This may enable the user to locate and place the input object 110 on the center position of the dial 502. When the input object 110 is moved to the left or right of the center position, the dial 502 may begin to rotate automatically in a carousel-like manner, with the speed of the rotation being incremental based on the distance of the input object 110 from the center position hole 112(5). Moving the input object 110 back to the center position hole 112(5) may cause the dial to cease rotation. The lesser amount of suction applied to holes 112(1)-112(4) and 112(6)-112(N) can provide feedback to the user regarding how far the user has moved the input object from the center position. Such a user interface may be useful for scrolling through large numbers of documents, content items, or the like. Furthermore, while FIGS. 4 and 5 illustrate several example user interfaces, numerous variations and numerous other types of interfaces and graphical elements will be apparent to those of skill in the art having the benefit of the disclosure herein.

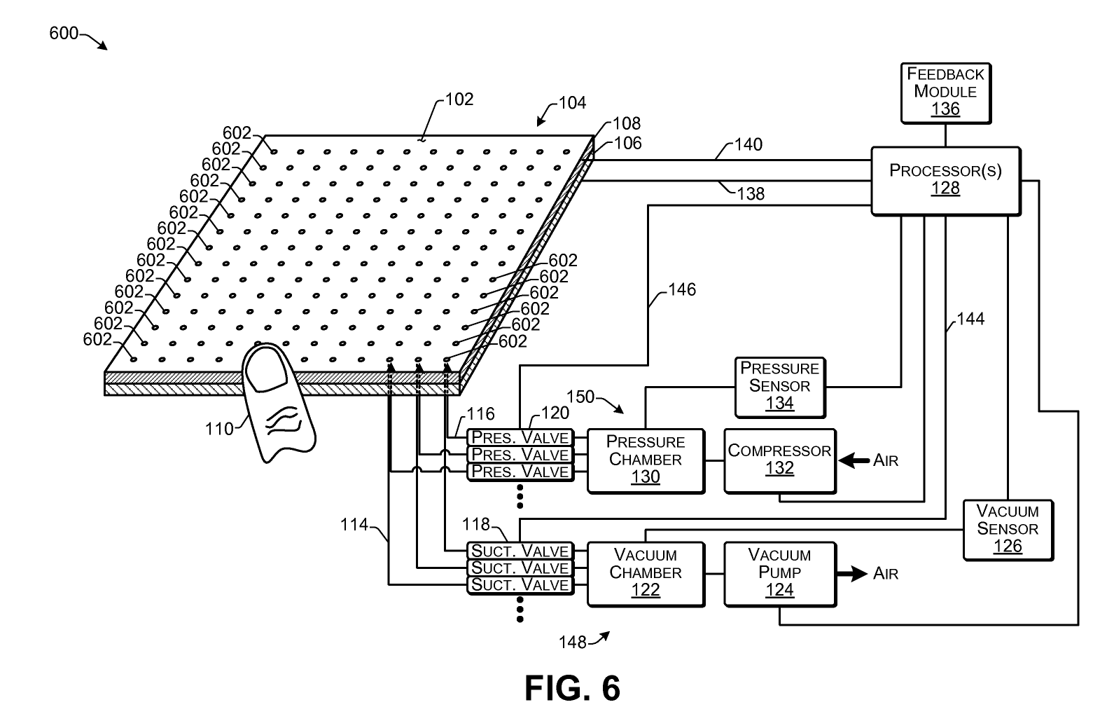

FIG. 6 illustrates an example apparatus 600 for providing tactile feedback according to some implementations. The apparatus 600 may include substantially the same components as discussed above with respect to the apparatus 100 of FIG. 1. However, the apparatus 600 includes a plurality of holes 602 in the touch surface 102, rather than the holes 112. For example, the holes 602 may be substantially smaller than the input object 110. Additionally, in some examples, the holes 602 may have a pitch between from each hole 602 to neighboring holes 602 such that multiple holes 602 may be concurrently encompassed, covered or otherwise placed under the input object 110. In some examples, the holes 602 may be between 1 mm and 4 mm in diameter, and may have a pitch between 0.5 cm and 5 cm, although various other hole diameters and pitches may be used, depending on the intended use of the apparatus 600. Each hole 602 may be selectively connectable to at least one of the suction source 148 or the pressure source 150, such as by opening respective suction valves 118 or pressure valves 120. Accordingly, each hole 602 may provide at least one of an attractive force or a repulsive force as feedback to the input object 110. The feedback provided by each of the holes 602 may be independently and selectively controlled by controlling respective individual valves 118 and 120 corresponding to each of the holes 602.

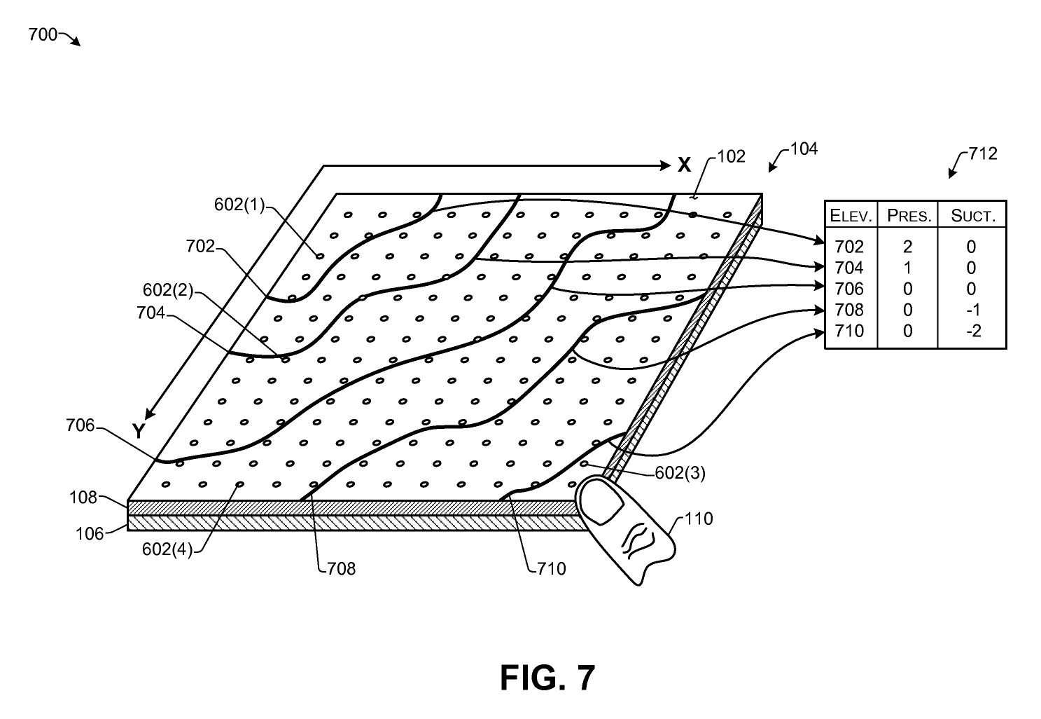

FIG. 7 illustrates the touch surface 102 of the example of FIG. 6 with an image 700 presented on the display 104 according to some implementations. In this example, the image 700 may be a map including elevation lines representative of a plurality of different elevations, such as a first elevation line 702, a second elevation line 704, a third elevation line 706, a fourth elevation line 708, and a fifth elevation line 710. For instance, suppose that the first elevation line 702 represents an elevation that is higher than an elevation represented by the second elevation line 704, and so forth, with the elevation represented by the fifth elevation line 710 being the lowest elevation represented on the current image 700.

In some examples, each of the holes 602 may have a known location based on an X-Y coordinate system corresponding to an X-axis and a Y-axis, as illustrated in FIG. 7. Furthermore, the location of the lines 702-710 in the image 700 may also be correlated to the X-Y coordinate system. Different pressure or suction values may be applied to each of the holes 602 depending on the location the respective hole 602 relative to lines 702-710 in the image 700 presented on the display 104. For instance, as illustrated, the hole 602(1) in the vicinity of the first elevation line 702 may have a positive pressure applied that is of a larger value than a positive pressure applied to the hole 602(2) which is in the vicinity of the second elevation line 704. For example, a pressure value of 2, which may correspond to the respective pressure valves being 50% opened, may be applied to holes, such as hole 602(1), that are closer to the elevation line 702 than to the other elevation lines 704-710. Similarly, the hole 602(3), which is near to the fifth elevation line 710, may have a suction applied thereto, such as a suction valve setting of −2, which may correspond to the respective suction valve being 50% open.

As illustrated in table 712 of FIG. 7, each different elevation line 702-710 may be associated with a different value of suction or positive air pressure, such as a pressure valve setting of 2 (50% open) for the first elevation line 702, a pressure valve setting of 1 (25% open) for the second elevation line 704, a pressure and suction valve setting of 0 for the third elevation line 706 (i.e. neither pressure nor suction is applied to the nearby holes), a suction valve setting of −1 (25% open) for the fourth elevation line 708, and a suction valve setting of −2 (50% open) for the fifth elevation line 710. Further, additional elevation lines not shown in the current view of the image 700 may represent higher or lower elevations, and may have respectively higher pressure valve settings or higher suction valve settings applied in their vicinity.

In some examples, the pressure or suction applied to each particular hole 602 may be determined based on the closest elevation line to the particular hole 602. In other examples, such as where the pressure and suction valves include more than five settings, interpolation may be performed to determine a value of pressure or suction to be applied to each hole 602. For example, the hole 602(4) may be determined to be halfway between the third elevation line 706 and the fourth elevation line 708. Based on interpolation, the suction valve for this hole 602(4) may be opened 12.5%. Such interpolation may be performed by the feedback module 136 for each of the holes 602 in the touch surface 102 to provide a smooth transition of tactile feedback between the different elevations. Alternatively, the interpolation may have been performed in advance, and may be provided as metadata with the image when presented on the display. Furthermore, in some examples, the respective pressure valves or suction valves may be opened only when the position of the input object 110 is detected within a threshold distance of the corresponding holes 602, such as 1 cm, 2 cm, or the like, depending on the response time of the valves.

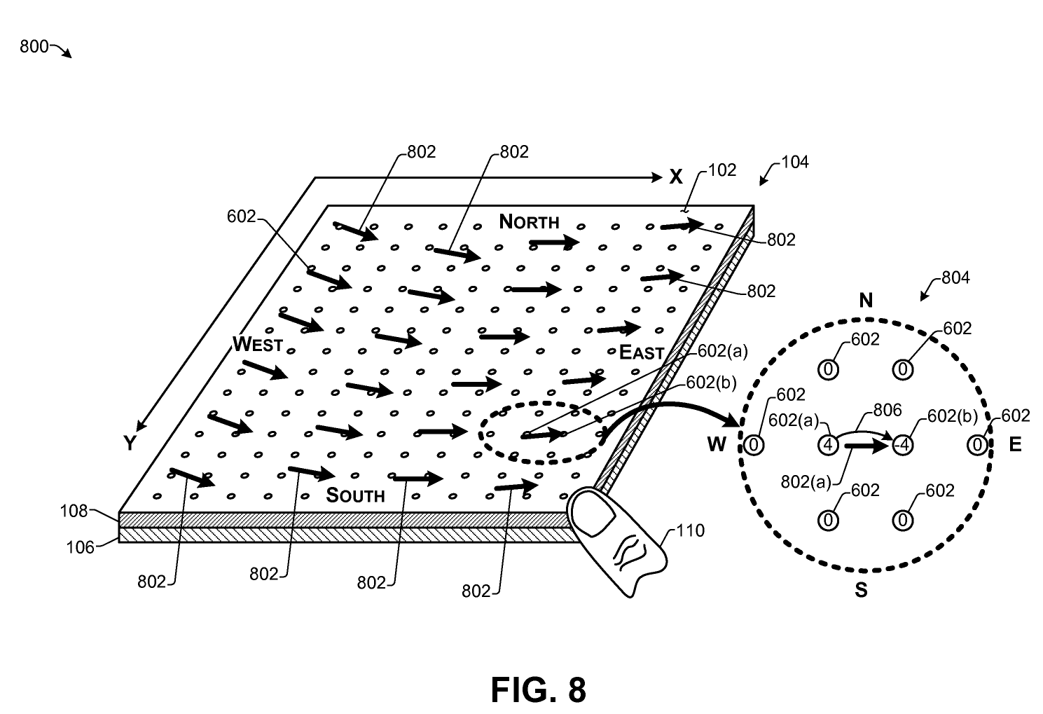

FIG. 8 illustrates the touch surface 102 of the example of FIG. 6 with an image 800 presented on the display 104 according to some implementations. In this example, the image 800 includes a plurality of arrows 802 represented on the display 104, along with indications of North, South, East, and West. The plurality of arrows 802 may represent wind vectors, ocean current vectors, or various other values. The airflow in and out of the holes 602 may be configured based at least in part on the arrows 802 included in the image 800. For example, as indicated in a magnified region 804, a first hole 602(a) near an origin end of an arrow 802(a) may be configured to emit pressurized air. Further a second hole 602(b) at an arrowhead end of the arrow 802(a) may have suction applied to draw air into the hole 802(b). This configuration can create a localized air current 806 that can be detected by a user's finger, and that may provide tactile feedback indicative of the air current, water current, etc., represented by the arrow 802(a).

Additionally, in some examples, the amount of positive pressure of the air emitted at the hole 602(a) and/or the amount of suction applied to the hole 602(b) may be controlled to indicate relative information regarding an attribute of the image feature being represented. For example, in the present example, large vectors 802 may be indicated by larger pressure and suction values, while smaller vectors 802 may be indicated by smaller pressure and suction values. In the example at 804 of FIG. 8, the respective valve settings are indicated by the numbers overlying each of the holes 602. Thus, the pressure and suction valves corresponding to the holes 602 surrounding the holes 602(a) and 602(b) are set to 0 in this example (i.e., closed), while the pressure valve for hole 602(a) is set to 4 (i.e., 100% open), and the suction valve for hole 602(b) is set to −4 (i.e., 100% open). Additionally, as mentioned above, the respective pressure valves or suction valves may be opened only when the position of the input object 110 is detected within a threshold proximate distance of the corresponding holes 602, such as 1 cm, 2 cm, or the like, depending on the response time of the valves, and other desired operational parameters.

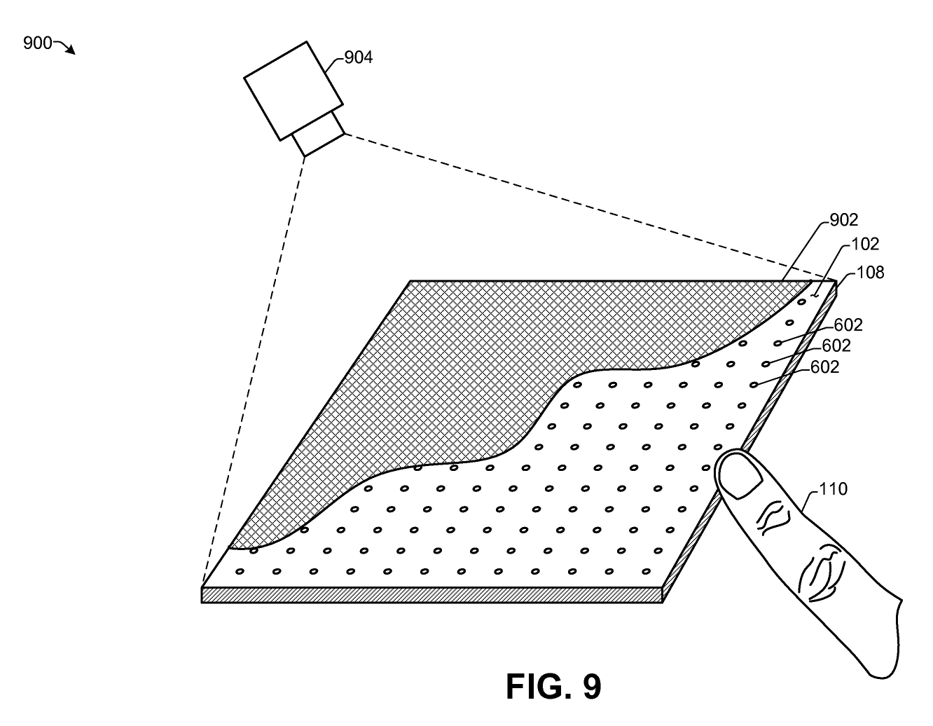

FIG. 9 illustrates an example apparatus 900 configured to provide attractive and repulsive force feedback with a projection display according to some implementations. In this example, the touch surface 102 may be covered with a mesh material 902 that permits airflow into and out of the holes 602 (or the holes 112 in other examples), but which may appear opaque, or at least semi-opaque, when an image is projected onto the mesh material 902 by a projector 904. Accordingly, the holes 602 (or 112) may not be visibly apparent to the user, but the attractive and repulsive force feedback provided by the holes 602 (or 112) may be detectable by the user's finger through the mesh material 902. In some examples, the mesh material may be a suitable cloth having an external reflective coating of a projection screen material, which may include materials such as magnesium carbonate, titanium dioxide or other bright reflective material. The touch sensor 108 may be tuned to detect touch inputs to the outer surface of the mesh material 902, which can serve as a touch surface for receiving user touch inputs, as well as a display surface for presenting a projected image.

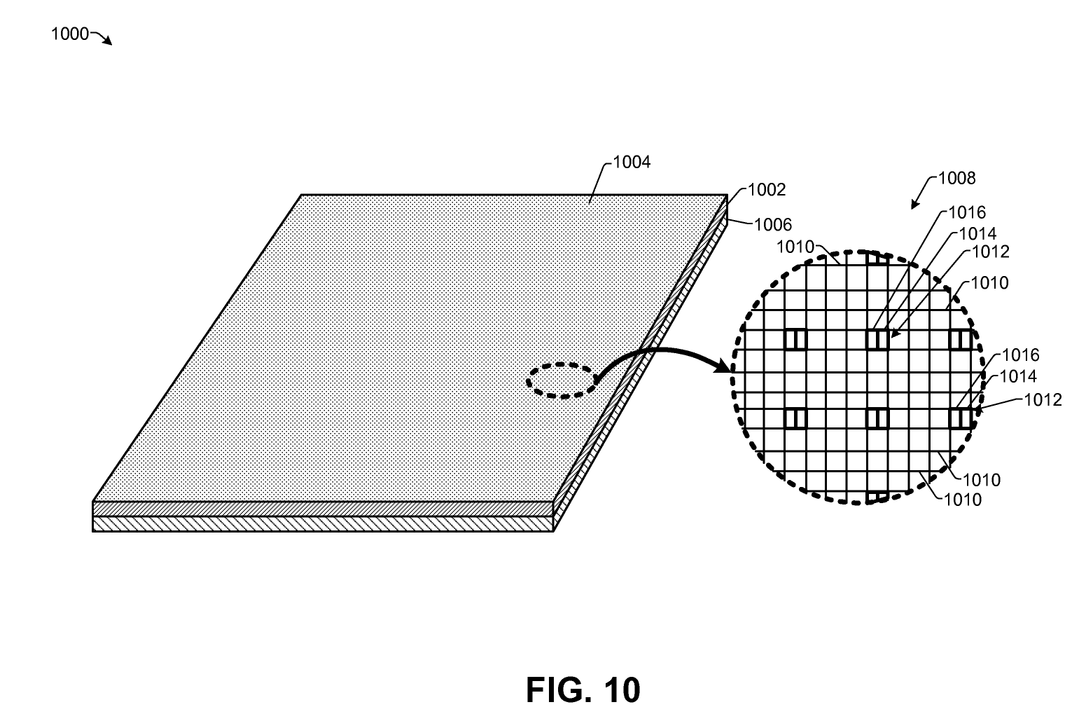

FIG. 10 illustrates an example apparatus 1000 configured to provide attractive and repulsive force feedback with a microelectromechanical system (MEMS) display according to some implementations. As one example, the apparatus 1000 may include a MEMS display that is an interferometric modulator display (IMOD), which can create various colors via interference of reflected light. The color may be selected with an electrically switched light modulator comprising a microscopic cavity that is switched on and off using driver integrated circuits similar to those used to address liquid crystal displays. An IMOD-based reflective display may include hundreds of thousands of individual IMOD pixel elements each of which may be a MEMS-based pixel element.

In the illustrated example, a MEMS display panel 1002, such as an IMOD panel, includes a touch surface 1004. A touch sensor 1006 may be located over or under the MEMS display panel 1002 and may be tuned to detect touch inputs made to the touch surface 1004. As illustrated in a magnified region 1008, the MEMS display panel 1002 may include a plurality of MEMS pixel elements 1010. Further, interspersed within the MEMS pixel elements 1010 are a plurality of holes 1012, which may be connectable to at least one of a suction source or a pressurized air source by operation of one or more respective valves. As one example, each hole 1012 may include a first MEMS valve 1014 for connecting to a suction source and a second MEMS valve 1016 for connecting to a pressurized air source. The MEMS valves 1014 and 1016 may be very small valves constructed using semiconductor fabrication technique, and may be individually controlled, such as by one or more processors 128 (not show in FIG. 10), as discussed above, for providing attractive and/or repulsive feedback to an input object. The MEMS valves 1014 and 1016 may be connected respectively to a suction source and a pressure source using any suitable techniques, such as those discussed above with respect to FIG. 1.

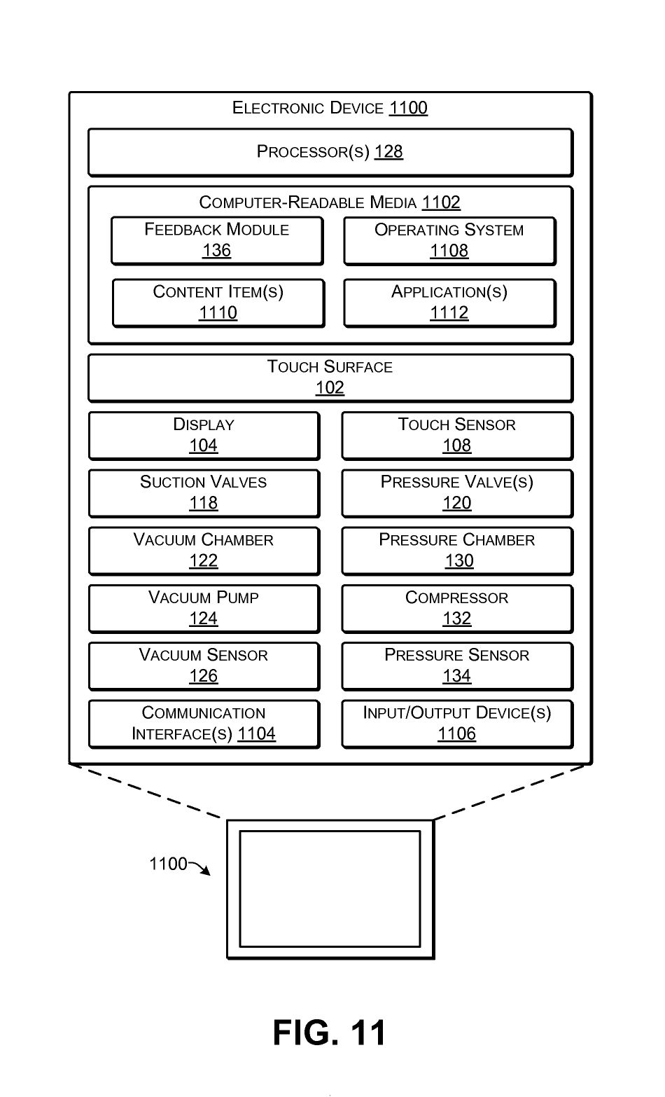

FIG. 11 illustrates select components of an example electronic device 1100 that may include or that may be associated with the apparatuses described herein according to some implementations. The electronic device 1100 may comprise any type of electronic device having a touch surface and a touch sensor. For instance, the electronic device 1100 may be a mobile electronic device (e.g., a tablet computing device, a laptop computer, a smart phone or other multifunction communication device, a portable digital assistant, an electronic book reader, a wearable computing device, an automotive display, etc.). Alternatively, the electronic device 1100 may be a non-mobile electronic device (e.g., a table-based computing system having a large form-factor tabletop touch surface, a desktop computer, a computer workstation, a television, an appliance, a cash register, etc.). Thus, the electronic device 1100 may be any type of electronic device having a touch sensitive touch surface 102, which may include touch sensitive displays, or which may be associated with a display that may not be touch sensitive.

In the illustrated example, the electronic device 1100 includes the one or more processors 128, one or more computer-readable media 1102, one or more communication interfaces 1104, and one or more input/output devices 1106. The processor(s) 128 can be a single processing unit or a number of processing units, all of which can include single or multiple computing units or multiple cores. The processor(s) 128 can be implemented as one or more microprocessors, microcomputers, microcontrollers, digital signal processors, central processing units, state machines, logic circuitries, and/or any devices that manipulate signals based on operational instructions. As one non-limiting example, the processor(s) 128 may be one or more hardware processors and/or logic circuits of any suitable type specifically programmed or configured to execute the algorithms and processes described herein. Among other capabilities, the processor(s) 128 can be configured to fetch and execute computer-readable, processor-executable instructions stored in the computer-readable media 1102. Computer-readable media 1102 includes, at least, two types of computer-readable media, namely computer storage media and communications media.

Computer storage media includes volatile and non-volatile, removable and non-removable media implemented in any method or technology for storage of information such as computer-readable, processor-executable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

By contrast, communication media may embody computer-readable, processor-executable instructions, data structures, program modules, or other data in a modulated data signal, such as a carrier wave, or other transmission mechanism. As defined herein, computer storage media does not include communication media.

Further, the electronic device 1100 may include the one or more communication interfaces 1104 that may facilitate communications between electronic devices. In particular, the communication interfaces 1104 may include one or more wired network communication interfaces, one or more wireless communication interfaces, or both, to facilitate communication via one or more networks.

Additionally, electronic device 1100 may include input/output devices 1106. The input/output devices 1106 may include a keyboard, a pointer device, (e.g. a mouse, trackball, joystick, stylus, etc.), buttons, switches, or other controls, one or more image capture devices (e.g., one or more cameras), microphones, speakers, and so forth. Further, the input/output devices 1106 may include various sensors, such as an accelerometer, a gyroscope, a global positioning system receiver, a compass, and the like.

The computer-readable media 1102 may include various modules and functional components for enabling the electronic device 1100 to perform the functions described herein. In some implementations, computer-readable media 1102 may include the feedback module 136 for controlling operation of the suction valves 118, the pressure valves 120, the vacuum pump 124, the compressor 132, and various other components of the electronic device 1100. For example, the feedback module 136 may detect a position of an input object with respect to the touch surface 102. In response to the detecting, the feedback module 136 may open one or more of the valves 118 or 120 to provide an attractive and/or repulsive tactile feedback to the input object. Furthermore, as discussed above, an operating system 1108, a content item 1110, or an application 1112 may generate a graphical element or other image on the display 104. In some examples, the feedback module 136 may control the suction or air pressure applied to one or more of the holes based at least in part on the image presented on the display 104 and/or metadata associated with the image. Additionally, the feedback module 136 may include a plurality of processor-executable instructions, which may comprise a single module of instructions or which may be divided into any number of modules of instructions. Furthermore, the computer-readable media 1102 may include other modules, such as an operating system, device drivers, and the like, as well as data used by the feedback module 136, the operating system 1108, the applications 1112 and/or other modules.

The example apparatuses, systems and electronic devices described herein are merely examples suitable for some implementations and are not intended to suggest any limitation as to the scope of use or functionality of the environments, apparatuses and devices that can implement the processes, components and features described herein. Thus, implementations herein are operational with numerous environments or apparatuses, and may be implemented in general purpose and special-purpose computing systems, or other devices having processing capability. Generally, any of the functions described with reference to the figures can be implemented using software, hardware (e.g., fixed logic circuitry) or a combination of these implementations.

Regardless of the specific implementation of the electronic device 1100, some examples of the electronic device 1100 may include the display 104. The display 104 may represent a reflective display in some instances, such as an electronic paper display, a reflective LCD display, or the like. Electronic paper displays may include an array of display technologies that imitate the appearance of ink on paper. Some examples of the electronic paper displays that may be used with the apparatuses described herein include bi-stable LCD displays, MEMS displays, such as interferometric modulator displays, cholesteric displays, electrophoretic displays, electrofluidic pixel displays, and the like. In other implementations, or for other types of devices 1100, the display 104 may be an active display such as a liquid crystal display, a plasma display, a light emitting diode display, an organic light emitting diode display, and so forth. In addition, in other examples, the display 104 may include a projector and a projection surface for presenting an image projected onto the projection surface by the projector. Of course, while several different examples have been given, the display 104 may comprise any suitable display technology for presenting an image in relation to the touch surface.

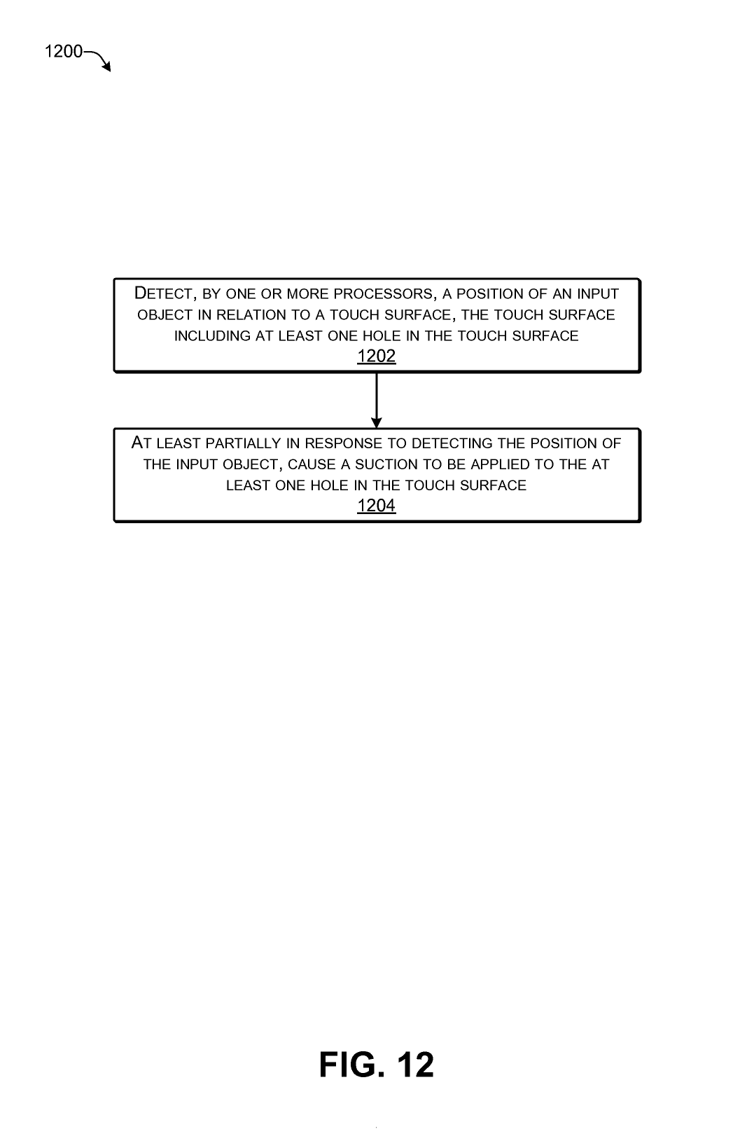

FIGS. 12-14 illustrate example processes according to some implementations. These processes are illustrated as a collection of blocks in logical flow diagrams, which represent a sequence of operations, some or all of which can be implemented in hardware, software or a combination thereof. In the context of software, the blocks represent processor-executable instructions stored on one or more computer-readable media that, when executed by one or more processors, may perform at least a portion of the recited operations. Generally, processor-executable instructions include routines, programs, objects, components, data structures and the like that perform particular functions or implement particular abstract data types. The order in which the operations are described should not be construed as a limitation. Any number of the described blocks can be combined in any order and/or in parallel to implement the process, or alternative processes, and not all of the blocks need be executed. For discussion purposes, the processes are described with reference to the apparatuses, devices and environments described in the examples herein, although the processes may be implemented in a wide variety of other apparatuses, devices or environments.

FIG. 12 illustrates an example process 1200 for providing tactile feedback according to some implementations. In some cases, the process 1200 may be implemented by one or more processors executing processor executable instructions.

At 1202, the one or more processors may detect a position of an input object in relation to a touch surface. For instance, the touch surface may include at least one hole in the touch surface. In some cases, the touch surface may include a plurality of holes, which may be controlled for drawing air into the holes or emitting pressurized air from the holes to provide tactile feedback to the input object.

At 1204, at least partially in response to detecting the position of the input object, the one or more processors may cause a suction to be applied to the at least one hole in the touch surface. For example, the one or more processors may apply the suction to cause air to flow into the at least one hole, which provides an attractive-force tactile feedback to the input object. As one example, the one or more processors may activate one or more respective suction valves to selectively connect the at least one hole to a suction source for drawing the air into the at least one hole.

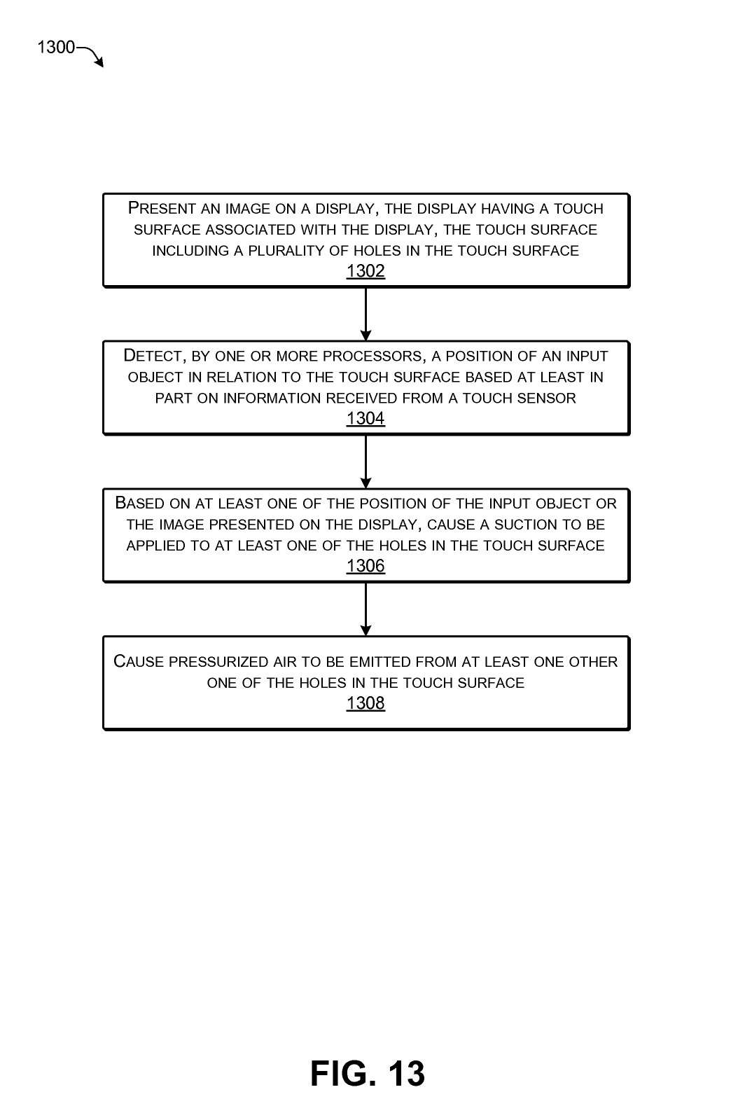

FIG. 13 illustrates an example process 1300 for providing tactile feedback according to some implementations. In some cases, the process 1300 may be implemented by one or more processors executing processor executable instructions.

At 1302, the one or more processors may present an image on a display. Further, a touch surface may be associated with the display and the touch surface may include a plurality of holes in the touch surface. In some examples, the display may be integral with the touch surface, while in other examples, the display may be separate from the touch surface.

At 1304, the one or more processors may detect a position of an input object in relation to the touch surface based at least in part on information received from a touch sensor. For example, various different types of touch sensors may be used for detecting the position of an input object in relation to the touch surface, as discussed above.

At 1306, based at least in part on at least one of the position of the input object or the image presented on the display, the one or more processors may cause a suction to be applied to at least one of the holes in the touch surface. For example, the suction may be applied to multiple different holes concurrently for providing various different types of attractive-force feedback effects to the input object.

At 1308, the one or more processors may further cause pressurized air to be admitted from at least one other hole in the touch surface. For example, suction may be applied to at least one hole while pressurized air may be emitted from at least one other hole. As another example, the same hole may alternately have suction applied or may emit pressurized air, such as based on changes in the image and/or the position of the input object.

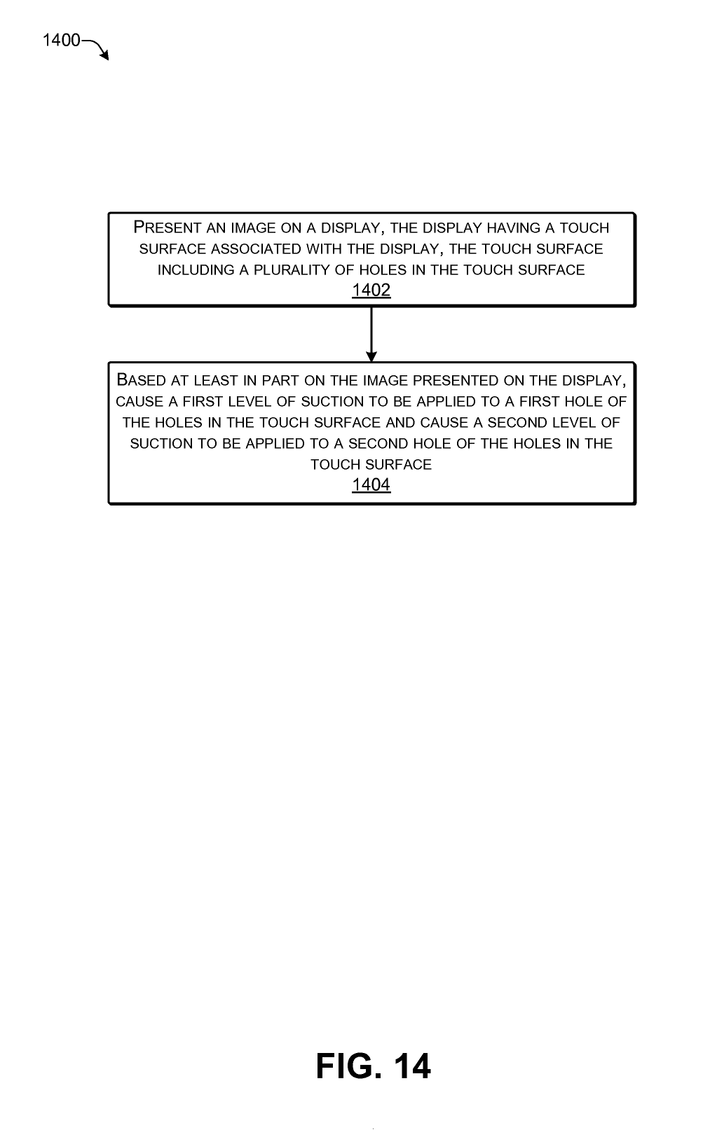

FIG. 14 illustrates an example process 1400 for providing tactile feedback according to some implementations. In some cases, the process 1400 may be implemented by one or more processors executing processor executable instructions.

At 1402, the one or more processors may present an image on a display. Furthermore, the display may be associated with a touch surface that includes a plurality of holes formed in the touch surface. In some examples, the display may be integral with the touch surface while in other examples, the display may be separate from the touch surface.

At 1404, based at least in part on the image presented on the display, the one or more processors may cause a first level of suction to be applied to a first hole of the holes in the touch surface, and may cause a second level of suction to be applied to a second hole of the holes in the touch surface. As one example, the image may include a graphic element, such as a slider or dial presented on the display, as discussed above. For instance, the graphic element may be positioned in relation to the multiple holes to cause the input object to traverse the multiple holes to interact with the graphic element. Some of the holes that correspond to the position of the graphic element may have a lower level of suction applied to the holes than others of the holes that correspond to an end position of the graphic element. For instance, the holes corresponding to the center portion of the graphic element may have a lower level of suction than the holes corresponding to the end positions of the graphic element.

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. An electronic device comprising:
a display able to present an image;
a suction source;
a touch surface having a plurality of holes selectively connectable to the suction source;
a touch sensor associated with the touch surface;
one or more processors configured by processor-executable instructions to perform functions including:
presenting an image on the display;
detecting a position of an input object in relation to the touch surface based at least in part on information received from the touch sensor; and
connecting at least one hole of the plurality of holes to the suction source based on at least one of:
the position of the input object, or
the image presented on the display.

2. The electronic device as recited in claim 1, further comprising a pressurized air source, wherein at least some of the plurality of holes are selectively connectable to the pressurized air source, the functions further comprising:
connecting at least one other hole of the plurality of holes to the pressurized air source based on the at least one of the detected location of the input object, or the image presented on the display.

3. The electronic device as recited in claim 1, further comprising a respective valve corresponding to each hole of the plurality of holes, wherein the connecting comprises opening at least one of the respective valves corresponding to the at least one hole.

4. The electronic device as recited in claim 3, wherein the connecting further comprises:
opening a first one of the respective valves corresponding to a first hole by a first amount to provide a first amount of suction at the first hole; and
opening a second one of the respective valves corresponding to a second hole by a second amount to provide a second amount of suction at the second hole, wherein the second amount of suction is different from the first amount of suction.

5. An apparatus comprising:
a touch surface;
a touch sensor for indicating a position of an input object in relation to the touch surface;
a hole in the touch surface; and
a suction source selectively connectable to the hole to cause air to flow into the hole when the hole is connected to the suction source.

6. The apparatus as recited in claim 5, one or more processors configured by processor-executable instructions to cause the air to flow into the hole based at least in part on a position of the input object in relation to the touch surface.

7. The apparatus as recited in claim 6, further comprising a pressurized air source selectively connectable to the hole, wherein the one or more processors are configured to selectively cause the air to flow into the hole or out of the hole based at least in part on the position of the input object in relation to the touch surface.

8. The apparatus as recited in claim 6, wherein:
the hole is one of multiple holes in the touch surface, each selectively connectable to at least one of the suction source or the pressurized air source; and
the one or more processors are configured to cause air to flow into a first hole of the multiple holes and cause air to flow out of a second hole of the multiple holes based at least in part on the position of the input object.

9. The apparatus as recited in claim 5, further comprising:
a display associated with the touch surface; and
one or more processors configured by processor executable instructions to cause air to flow into the hole at least partially based on an image presented on the display.

10. The apparatus as recited in claim 9, wherein the display includes at least one of:
a projector and a projection surface;
a liquid crystal display;
a light emitting diode display;
a plasma display;
an organic light emitting diode display;
a microelectromechanical system display; or
an electronic paper display.

11. The apparatus as recited in claim 9, wherein:
the hole is one of multiple holes in the touch surface, each selectively connectable to the suction source; and
the image presented on the display includes a graphic element, wherein the graphic element is positioned in relation to the multiple holes to cause the input object to traverse the multiple holes to interact with the graphic element.

12. The apparatus as recited in claim 5, wherein the hole is one of multiple holes in the touch surface, the apparatus further comprising respective suction valves located between respective ones of the holes and the suction source for selectively connecting the holes the suction source.

13. The apparatus as recited in claim 12, wherein individual ones of the suction valves are controllable to apply a first level of suction to a first hole of the multiple holes and a second level of suction to a second hole of the multiple holes.

14. The apparatus as recited in claim 5, further comprising a mesh material over the hole, the mesh material allowing airflow in and out of the hole.

15. A method comprising:
detecting, by one or more processors, a position of an input object in relation to a touch surface, the touch surface including at least one hole in the touch surface; and
at least partially in response to the detecting, causing a suction to be applied to the at least one hole in the touch surface.

16. The method as recited in claim 15, wherein the touch surface includes a plurality of holes in the touch surface, the method further comprising:
causing the suction to be applied to a first hole of the plurality of holes; and
causing pressurized air to be emitted from a second hole of the plurality of holes.

17. The method as recited in claim 15, the method further comprising:
detecting an updated position of the input object;
based at least in part on the updated position of the input object, ceasing application of the suction to the at least one hole; and
causing pressurized air to be emitted from the at least one hole.

18. The method as recited in claim 15, wherein the causing the suction to be applied to the at least one hole in the touch surface comprises opening at least one valve connecting the at least one hole to a suction source.

19. The method as recited in claim 15, wherein the detecting the position of the input object further comprises receiving, from a touch sensor, information indicating the position of the input object as at least one of touching or proximate to the touch surface.

20. The method as recited in claim 15, wherein the touch surface is associated with a display, the method further comprising:
presenting an image on the display; and
causing the suction to be applied to the at least one hole in the touch surface based at least in part on the image presented on the display.
